(19) United States
(12) Patent Application Publication
(10) Pub. No.: US 2020/0275374 A1
(43) Pub. Date: Aug. 27, 2020

(54) SERVICE CONTROL APPARATUS, MOBILITY MANAGEMENT APPARATUS, SERVICE CONTROL METHOD, AND NON-TRANSITORY COMPUTER READABLE MEDIUM

(71) Applicant: NEC CORPORATION, Tokyo (JP)

(72) Inventors: Akira KAMEI, Tokyo (JP); Toru YAMADA, Tokyo (JP); Yumiko OKUYAMA, Tokyo (JP); Kyoji HIRATA, Tokyo (JP); Masahiro SERIZAWA, Tokyo (JP); Satoshi HASEGAWA, Tokyo (JP); Masashi SHIMOMA, Tokyo (JP)

(73) Assignee: NEC CORPORATION, Tokyo (JP)

(21) Appl. No.: 16/646,194

(22) PCT Filed: May 10, 2018
(86) PCT No.: PCT/JP2018/018094

§ 371 Date: Mar. 11, 2020

(30) Foreign Application Priority Data
Sep. 21, 2017 (JP) 2017-181503

(51) Int. Cl. H04W 52/02; H04W 72/04; H04W 8/08; H04W 76/28

(52) U.S. Cl. CPC H04W 52/0235; H04W 72/04; H04W 88/18; H04W 76/28; H04W 8/08

(57) ABSTRACT

A service control apparatus (20) according to the present disclosure includes: a communication unit (21) configured to receive, from a service providing apparatus (30), downlink data destined for a communication terminal (10), and information about a maximum allowable delay time of the downlink data; and a control unit (22) configured to determine whether the maximum allowable delay time expires by a communication enabled timing at which the communication terminal (10) in a power saving state can next perform communication, in which when the maximum allowable delay time expires by the communication enabled timing, the communication unit (21) transmits, to the service providing apparatus (30), information indicating that the downlink data cannot be transmitted to the communication terminal (10).

### TECHNICAL FIELD

The present disclosure relates to a service control apparatus, a mobility management apparatus, a service control method, and a program.

### BACKGROUND ART

In recent years, 3GPP (3rd Generation Partnership Project) has been discussing network configurations for implementing communication between a large number of Machine Type Communication (MTC) terminals connected to a network and server apparatuses. Specifically, a discussion on an interface between a Services Capability Server (SCS) and a Service Capability Exposure Function (SCEF) entity (hereinafter referred to as an SCEF) has been conducted. The SCS connects to a plurality of Application Servers (AS). The SCEF is a node disposed in a mobile network. The SCS is used as a service platform that accommodates a plurality of ASs. The mobile network is a network composed of node apparatuses the specifications of which are defined in 3GPP.

It should be noted that Non-Patent Literature 1 defines that a T8 Reference Point is provided as an interface between the SCS and the SCEF.

For example, as a common parameter transmitted in the T8 Reference Point, a T8 Transaction Reference ID (TTRI), a T8 Long Term Transaction Reference ID (TLTRI), a T8 Destination Address, an Accuracy, an Idle Status Indication, and the like are defined.

Further, Non-Patent Literature 1 discloses a Non-IP Data Delivery (NIDD) procedure (NIDD Procedure) between the SCS and the MTC terminal. In the following description, the MTC terminal will be described as a User Equipment (UE), which is a general term used for communication terminals in 3GPP. The NIDD Procedure includes a Mobile Originated (MO) NIDD Procedure in which a UE starts an NIDD, and a Mobile Terminated (MT) NIDD Procedure in which a server apparatus starts an NIDD.

In the MT NIDD Procedure, the SCS transmits an MT NIDD Submit Request to the SCEF via the T8 Reference Point, thereby starting the MT NIDD Procedure. The MT NIDD Submit Request includes a Mobile Subscriber Integrated Services Digital Network Number (MSISDN), a TTRI, a TLTRI, Non-IP Data, a Maximum Latency, and the like. The MSISDN is identification information of a UE that is the delivery destination of the Non-IP Data. The Non-IP Data is data destined for the UE, and may be referred to as downlink data. The Maximum Latency indicates the maximum allowable delay time of the Non-IP Data (the downlink data). The Maximum Latency may be a time required from when the SCS transmits the Non-IP Data to when the UE receives the Non-IP Data. Alternatively, the Maximum Latency may be a time required from when the SCS transmits the Non-IP Data to when the SCS receives a result of the delivery confirmation of the Non-IP data. Alternatively, the Maximum Latency may be a time for the SCEF to perform buffering.

When the SCEF receives the Non-IP Data from the SCS, the SCEF is disposed in a mobile network, and then the SCEF transmits the Non-IP Data to a Mobile Management Entity (MME) or a Serving General Packet Radio Service Support Node (SGSN) that performs mobility management of the UE. After that, the MME or the SGSN delivers the Non-IP Data to the UE via a base station apparatus or the like.

### CITATION LIST

### Non Patent Literature

Non Patent Literature 1: 3GPP TS23.682 V15.1.0 (2017-06)

### SUMMARY OF INVENTION

### Technical Problem

A UE commonly uses a battery, and therefore it is desired that power consumption be reduced. Accordingly, a UE executes a function such as a Power Saving Mode (PSM) or a Discontinuous Reception (DRX) to achieve a reduction in power consumption. Further, the MTC terminal is a small terminal such as a sensor, and therefore the introduction of an eDRX (an extended DRX) function, which can further extends a communication interval as compared with a DRX, has been discussed in order to achieve a further reduction in power consumption.

In the PSM function, a recovery time to recover from a state in which some functions are stopped and communication cannot be performed to a state in which communication can be performed is determined. Further, in the DRX or the eDRX function, a time interval for intermittently receiving a signal transmitted from a base station is determined.

It should be noted that the time determined in the PSM function or the DRX function, that is, the time during which communication cannot be performed, may be longer than the Maximum Latency. In such a case, the SCEF or the mobile network cannot deliver the Non-IP Data to the UE within the time of the Maximum Latency specified by the SCS. If the SCEF cannot deliver the Non-IP Data to the UE, it is conceivable that the SCEF sends the result of delivery to the SCS after the time determined in the Maximum Latency expires. This causes a problem that the SCS cannot recognize the result that the Non-IP Data cannot be delivered to the UE until the Maximum Latency expires.

An object of the present disclosure is to provide a service control apparatus, a mobility management apparatus, a service control method, and a program in which an SCS can recognize that, when a mobile network cannot deliver Non-IP Data to a UE, the Non-IP Data is not delivered to the UE before a Maximum Latency expires.

### Solution to Problem

A service control apparatus according to a first aspect of the present disclosure includes: a communication unit configured to receive, from a service providing apparatus, downlink data destined for a communication terminal, and information about a maximum allowable delay time of the downlink data; and a control unit configured to determine whether the maximum allowable delay time expires by a communication enabled timing at which the communication terminal in a power saving state can next perform communication, in which when the maximum allowable delay time expires by the communication enabled timing, the communication unit transmits, to the service providing apparatus, information indicating that the downlink data cannot be transmitted to the communication terminal.

A mobility management apparatus according to a second aspect of the present disclosure includes: a determination unit configured to determine a communication enabled timing at which a communication terminal in a power saving state can next perform communication; and a communication unit configured to transmit information about the communication enabled timing to a service providing apparatus configured to determine whether a maximum allowable delay time of downlink data destined for the communication terminal expires by the communication enabled timing at which the communication terminal in a power saving state can next perform communication.

A service control method according to a third aspect of the present disclosure includes: receiving, from a service providing apparatus, downlink data destined for a communication terminal, and information about a maximum allowable delay time of the downlink data; determining whether the maximum allowable delay time expires by a communication enabled timing at which the communication terminal in a power saving state can next perform communication; and transmitting, to the service providing apparatus, information indicating that the downlink data cannot be transmitted to the communication terminal when the maximum allowable delay time expires by the communication enabled timing.

A program according to a fourth aspect of the present disclosure is a program for causing a computer to: receive, from a service providing apparatus, downlink data destined for a communication terminal, and information about a maximum allowable delay time of the downlink data; determine whether the maximum allowable delay time expires by a communication enabled timing at which the communication terminal in a power saving state can next perform communication; and transmit, to the service providing apparatus, information indicating that the downlink data cannot be transmitted to the communication terminal when the maximum allowable delay time expires by the communication enabled timing.

### Advantageous Effects of Invention

According to the present disclosure, it is possible to provide a service control apparatus, a mobility management apparatus, a service control method, and a program in which an SCS can recognize that, when a mobile network cannot deliver Non-IP Data to a UE, the Non-IP Data is not delivered to the UE before a Maximum Latency expires.

### BRIEF DESCRIPTION OF DRAWINGS

FIG. 1 is a configuration diagram of a communication system according to a first example embodiment;

FIG. 2 is a configuration diagram of a communication system according to a second example embodiment;

FIG. 3 is a configuration diagram of an MME according to the second example embodiment;

FIG. 4 is a diagram for explaining an NIDD procedure according to the second example embodiment;

FIG. 5 is a diagram for explaining an NIDD procedure according to a third example embodiment; and

FIG. 6 is a configuration diagram of an MME, an SGSN, and an SCEF according to each of the example embodiments.

### DESCRIPTION OF EMBODIMENTS

### First Example Embodiment

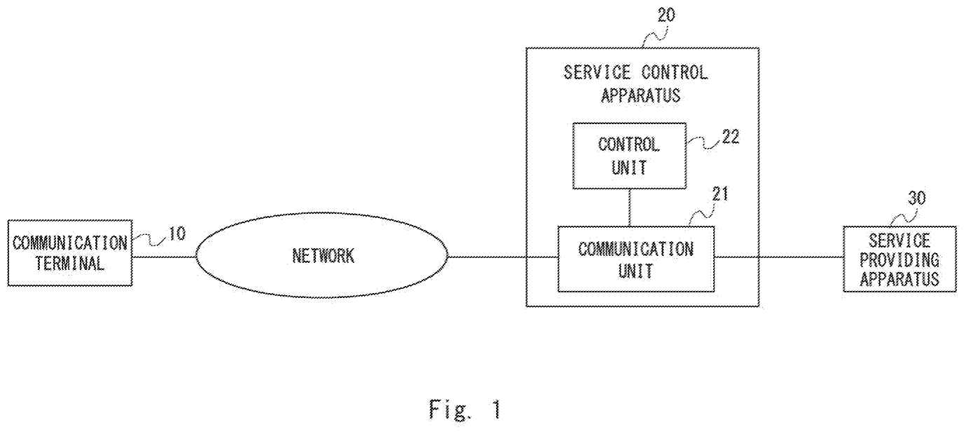

Hereinafter, with reference to the drawings, example embodiments of the present disclosure will be described. A configuration example of a communication system according to a first example embodiment of the present disclosure is described with reference to FIG. 1. The communication system shown in FIG. 1 includes a communication terminal 10, a service control apparatus 20, and a service providing apparatus 30. Further, the communication terminal 10 communicates with the service control apparatus 20 via a network. For example, the network may be a wireless network or a core network. It is assumed that the service control apparatus 20 is disposed in the core network. Further, a network including the communication terminal 10 and the service control apparatus 20 may be referred to as a mobile network.

The communication terminal 10, the service control apparatus 20, and the service providing apparatus 30 may each be a computer apparatus operated by a processor executing a program stored in a memory.

The communication terminal 10 may be a mobile telephone terminal or a smartphone terminal. Alternatively, the communication terminal 10 may be an MTC terminal or a Machine to Machine (M2M) terminal.

The service providing apparatus 30 is an apparatus that provides a communication service to the communication terminal 10. The communication service may be rephrased, for example, as an application service. The service providing apparatus 30 may be a server apparatus that provides a service.

The service control apparatus 20 is an apparatus that performs authentication processing and the like related to the service providing apparatus 30. The service control apparatus 20 may be a server apparatus that performs control related to a service provided to the communication terminal 10. The service control apparatus 20 is disposed between the communication terminal 10 and the service providing apparatus 30.

Next, a configuration example of the service control apparatus 20 is described. The service control apparatus 20 includes a communication unit 21 and a control unit 22. The communication unit 21 and the control unit 22 may be software or modules, the processing of which is executed by a processor executing a program stored in a memory. Alternatively, the communication unit 21 and the control unit 22 may be hardware such as circuits or chips.

The communication unit 21 receives, from the service providing apparatus 30, downlink data destined for the communication terminal 10 and information about a maximum allowable delay time of the downlink data. The downlink data may be, for example, Non-IP Data destined for the communication terminal 10. Further, the maximum allowable delay time may be referred to as a Maximum Latency. The maximum allowable delay time may be a time required from when the service providing apparatus 30 transmits downlink data to when the communication terminal 10 receives the downlink data. Alternatively, the maximum allowable delay time may be a time required from when the service providing apparatus 30 transmits downlink data to when the service providing apparatus 30 receives a result of the delivery confirmation of the downlink data. The result of the delivery confirmation is information indicating whether the communication terminal 10 has received downlink data. Alternatively, the maximum allowable delay time may be a time for the service control apparatus 20 to perform buffering.

The control unit 22 determines whether the maximum allowable delay time expires by a communication enabled timing at which the communication terminal 10 in a power saving state can next perform communication. The communication terminal 10 in a power saving state is in a state in which, for example, some functions are stopped to reduce power consumption more than usual. The communication terminal 10 in a power saving state is in a state in which, for example, a communication function for communicating with a network is stopped and communication cannot be performed.

For the communication terminal 10 in a state in which the communication function is stopped and communication cannot be performed, a communication enabled timing at which the communication terminal 10 can next perform communication is determined in advance. The communication enabled timing at which the communication terminal 10 can next perform communication may be, for example, a timing at which the communication function is operated. The control unit 22 compares, with the maximum allowable delay time, the time from the present time to the communication enabled timing at which the communication terminal 10 can next perform communication. The present time may be, for example, a timing at which the control unit 22 receives downlink data and information about the maximum allowable delay time of the downlink data from the service providing apparatus 30.

When the maximum allowable delay time is shorter than the time from the present time to the communication enabled timing at which the communication terminal 10 can next perform communication, the control unit 22 determines that the maximum allowable delay time expires by the communication enabled timing at which the communication terminal 10 in a power saving state can next perform communication. When the maximum allowable delay time is longer than the time from the present time to the communication enabled timing at which the communication terminal 10 can next perform communication, the control unit 22 determines that the maximum allowable delay time does not expire by the communication enabled timing at which the communication terminal 10 in a power saving state can next perform communication.

When the maximum allowable delay time expires by the communication enabled timing at which the communication terminal 10 in a power saving state can next perform communication, the service control apparatus 20 cannot transmit downlink data to the communication terminal 10. In this example, transmission may be rephrased as delivery, distribution, or the like.

Therefore, the communication unit 21 transmits, to the service providing apparatus 30, information indicating that downlink data cannot be transmitted to the communication terminal 10 when the maximum allowable delay time expires by the communication enabled timing at which the communication terminal 10 in a power saving state can next perform communication.

As described above, the service control apparatus 20 can transmit information to the service providing apparatus 30 when the maximum allowable delay time expires by the communication enabled timing at which the communication terminal 10 in a power saving state can next perform communication. Specifically, the service control apparatus 20 can transmit information indicating that downlink data cannot be transmitted to the communication terminal 10. The service control apparatus 20 can determine whether downlink data can be transmitted to the communication terminal 10 before the maximum allowable delay time expires.

As a result, the service providing apparatus 30 can recognize that downlink data cannot be transmitted to the communication terminal 10 before the maximum allowable delay time expires. In such a case, the service providing apparatus 30 can start, after the maximum allowable delay time expires, processing for resetting the maximum allowable delay time earlier than when it recognizes that Non-IP data cannot be delivered. Alternatively, the service providing apparatus 30 can start, after the maximum allowable delay time expires, processing such as processing for determining a timing at which Non-IP Data is retransmitted earlier than when it recognizes that Non-IP data cannot be delivered.

### Second Example Embodiment

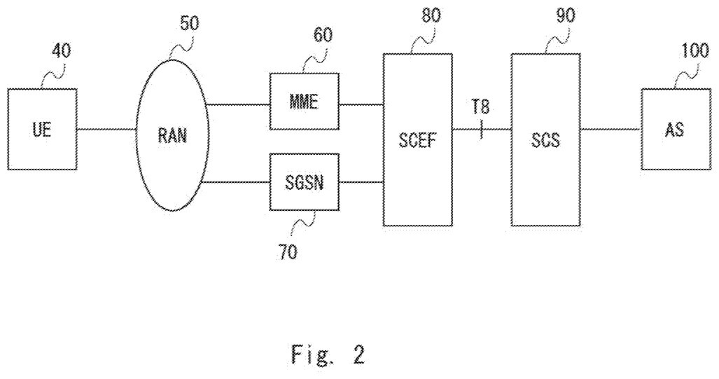

Next, a configuration example of a communication system according to a second example embodiment of the present disclosure is described with reference to FIG. 2. The communication system shown in FIG. 2 is composed of node apparatuses, the standards or the specifications of which are defined in 3GPP. The communication system shown in FIG. 2 includes a UE 40, a Radio Access Network (RAN) 50, an MME 60, an SGSN 70, an SCEF 80, an SCS 90, and an AS 100. The T8 Reference Point is provided between the SCEF 80 and the SCS 90.

The UE 40 corresponds to the communication terminal 10 shown in FIG. 1. The SCEF 80 corresponds to the service control apparatus 20 shown in FIG. 1. That is, the configuration of the SCEF 80 is similar to that of the service control apparatus 20. The SCS 90 and the AS 100 correspond to the service providing apparatus 30 shown in FIG. 1. In the following description, the SCS 90 and the AS 100 may be described as SCS 90/AS 100, as being apparatuses for providing a service. Further, FIG. 2 shows a configuration in which the SCS 90 connects to one AS 100, but the SCS 90 may be connected to a plurality of ASs.

The RAN 50 may include a Radio Network Controller (RNC), a Node B that supports 2G (Generation) or 3G as a radio communication system, an evolved Node B (eNB) that supports Long Term Evolution (LTE) as a radio communication method, and the like. The UE 40 performs radio communication with the Node B or the eNB.

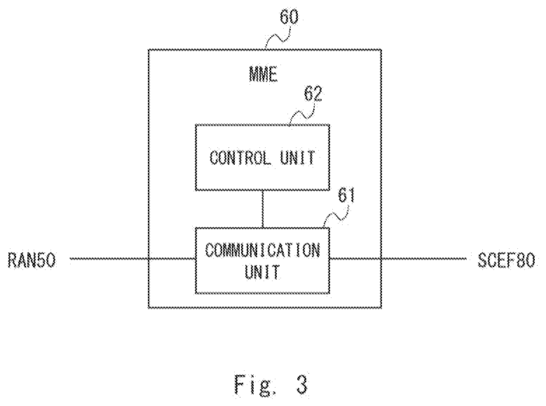

Next, a configuration example of the MME 60 is described with reference to FIG. 3. Note that the configuration of the SGSN 70 is similar to that of the MME 60, and thus detailed description thereof is omitted.

The MME 60 includes a communication unit 61 and a control unit 62. The communication unit 61 and the control unit 62 may be software or modules, the processing of which is executed by a processor executing a program stored in a memory. Alternatively, the communication unit 61 and the control unit 62 may be hardware such as circuits or chips.

When the communication unit 61 receives, from the SCEF 80, an inquiry message about a communication enabled timing at which the UE 40 in a power saving state can next perform communication, the communication unit 61 transmits information about the communication enabled timing of the UE 40 to the SCEF 80. The information about the communication enabled timing of the UE 40 may be information about a time, or may be information about a period or a time until the communication enabled timing comes.

The UE 40 in a power saving state may be in a state in which, for example, the PSM performs a power saving operation. In contrast to the PSM that performs a power saving operation, a state in which a power saving operation is not performed is defined as a state in which the operation is performed in a normal mode. Alternatively, the UE 40 in a power saving state may be in a state in which communication is not performed in the DRX or the eDRX. In contrast to a state in which communication is not performed in the DRX or the eDRX, a state in which communication can be performed is defined as a data standby state or a data standby timing. Further, a state in which the UE 40 is in a power saving state and communication cannot be performed may be referred to as an idle state.

Further, when the communication unit 61 receives Non-IP Data corresponding to downlink data from the SCEF 80, the communication unit 61 transmits the Non-IP Data to the UE 40 via the RAN 50.

When the control unit 62 receives, from the SCEF 80, an inquiry message about the communication enabled timing at which the UE 40 in a power saving state can next perform communication, the control unit 62 outputs information about the communication enabled timing of the UE 40 to the communication unit 61. The control unit 62 may extract information about the communication enabled timing of the UE 40 from information about the UE 40 stored in a memory or the like in the MME 60. Alternatively, the control unit 62 may acquire information about the communication enabled timing of the UE 40 from apparatuses different from the MME 60, such as a Home Subscriber Server (HSS) that manages subscriber information of the UE 40.

Further, the control unit 62 detects that the UE 40 has been brought into a state in which communication can be performed from a power saving state in which communication cannot be performed. In other words, the control unit 62 detects that the UE 40 being operated in the PSM has made a transition to a normal mode or that the UE 40 being operated in the DRX or the eDRX has come to a data standby timing. For example, when the control unit 62 receives a message notifying that communication can be performed from the UE 40, or when the time indicated by the communication enabled timing of the UE 40 has come, the control unit 62 determines that the UE 40 has been brought into a state in which communication can be performed.

In this case, the control unit 62 transmits, to the SCEF 80 via the communication unit 61, information indicating that the UE 40 has come to a communication enabled timing.

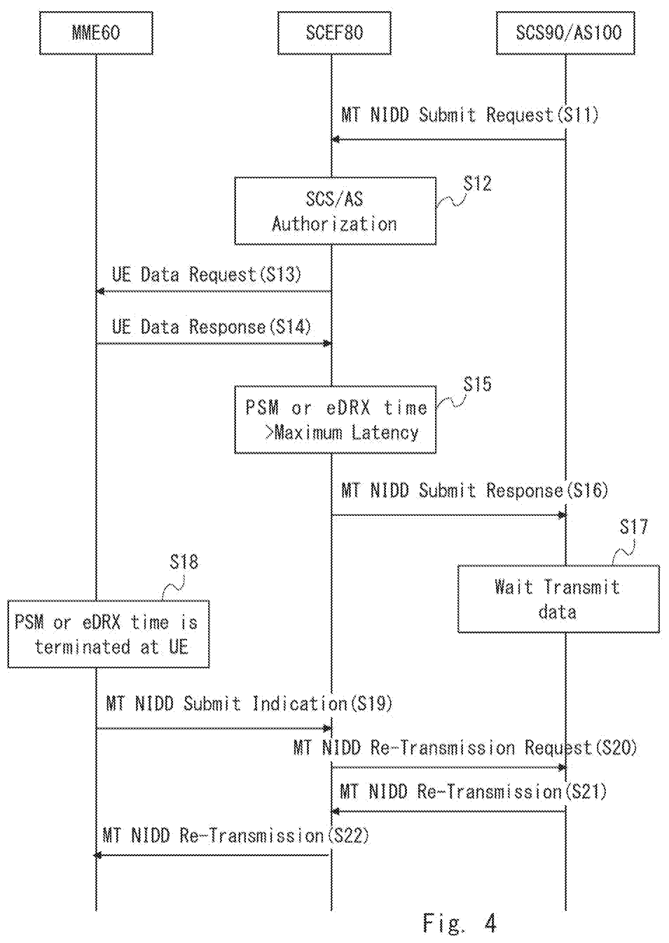

Next, an NIDD procedure according to the second example embodiment of the present disclosure is described with reference to FIG. 4. First, the SCS 90/AS 100 transmits an MT NIDD Submit Request message to the SCEF 80 via the T8 Reference Point (S11). The MT NIDD Submit Request message includes identification information of the UE 40, Non-IP Data, and a Maximum Latency of the Non-IP Data.

Next, the SCEF 80 performs authentication processing as to whether the SCS 90/AS 100 can transmit the Non-IP Data to the UE 40 (S12). For example, the SCEF 80 may manage a database that associates an SCS with a UE in which the SCS can transmit Non-IP Data. Alternatively, the SCEF 80 may inquire to the HSS, or an authentication server and the like whether the SCS 90/AS 100 can transmit the Non-IP Data to the UE 40. The HSS manages a database that associates an SCS with a UE in which the SCS can transmit Non-IP Data. Further, the database may manage a list of the SCSs that can transmit Non-IP Data. The following description is based on the assumption that the SCEF 80 determines that the SCS 90/AS 100 can transmit the Non-IP Data to the UE 40.

Further, in Step S12, the SCEF 80 may check whether the amount of data of the Non-IP Data received from the SCS 90/AS 100 exceeds an Evolved Packet System (EPS) bearer about the UE 40 set in the mobile network. Alternatively, the SCEF 80 may check whether the communication rate received from the SCS 90/AS 100 exceeds the EPS bearer about the UE 40 set in the mobile network. If the SCEF 80 determines that the amount of data of the Non-IP Data exceeds the EPS bearer about the UE 40 set in the mobile network, the SCEF 80 may transmit, to the SCS 90/AS 100, a message rejecting that the SCS 90/AS 100 transmits the Non-IP Data. Alternatively, if the SCEF 80 determines that the communication rate exceeds the EPS bearer about the UE 40, the SCEF 80 may transmit, to the SCS 90/AS 100, a message rejecting that the SCS 90/AS 100 transmits the Non-IP Data. The following description is based on the assumption that the amount of data or the communication rate of the Non-IP Data received from the SCS 90/AS 100 does not exceed the EPS bearer.

Next, the SCEF 80 transmits a UE Data Request message to the MME 60 (S13). The UE Data Request message is used to ask for information about the next communication enabled timing of the UE 40 in a power saving state.

Next, the MME 60 transmits, to the SCEF 80, a UE Data Response message including the information about the next communication enabled timing of the UE 40 in a power saving state (S14). Next, the SCEF 80 determines whether the time until the next communication enabled timing of the UE 40 in a power saving state comes exceeds the Maximum Latency of the Non-IP Data (S15). The following description is based on the assumption that the SCEF 80 determines that the time until the next communication enabled timing of the UE 40 in a power saving state comes exceeds the Maximum Latency of the Non-IP Data.

Next, the SCEF 80 transmits an MT NIDD Submit Response message to the SCS 90/AS 100 (S16). The MT NIDD Submit Response message includes information indicating that the Non-IP Data cannot be transmitted to the UE 40 since the time until the next communication enabled timing of the UE 40 in a power saving state comes exceeds the Maximum Latency of the Non-IP Data.

If the SCS 90/AS 100 receives the MT NIDD Submit Response message, it does not transmit the Non-IP Data and waits (S17). For example, if the time until the next communication enabled timing of the UE 40 in a power saving state comes exceeds the Maximum Latency of the Non-IP Data, the SCS 90/AS 100 may not transmit the Non-IP Data and wait. In other words, if the SCS 90/AS 100 cannot transmit the Non-IP Data to the UE 40 due to any other reason, the SCS 90/AS 100 may again transmit the Non-IP Data to the SCEF 80 without waiting for transmission of the Non-IP Data. The aforementioned reason may be a reason other than the fact that the time until the next communication enabled timing of the UE 40 in a power saving state comes exceeds the Maximum Latency of the Non-IP Data.

Next, the MME 60 detects that the UE 40 has come to the communication enabled timing and has been brought into a state in which communication can be performed (S18). Next, the MME 60 transmits an MT NIDD Submit Indication message to the SCEF 80 (S19). The MT NIDD Submit Indication message is used to notify the SCEF 80 that the UE 40 has been brought into a state in which communication can be performed.

Next, the SCEF 80 transmits an MT NIDD Re-Transmission Request message to the SCS 90/AS 100 (S20). The MT NIDD Re-Transmission Request message is used to notify the SCS 90/AS 100 that the SCS 90/AS 100 is requested to retransmit the Non-IP Data.

Next, the SCS 90/AS 100 transmits the MT NIDD Re-Transmission message including the Non-IP Data to the SCEF 80 (S21). Next, the SCEF 80 transmits the MT NIDD Re-Transmission message including the Non-IP Data received from the SCS 90/AS 100 to the MME 60 (S22). The MME 60 delivers the received Non-IP Data to the UE 40.

As described above, the SCS 90 can recognize whether it can transmit the Non-IP Data to the UE 40 before the Maximum Latency elapses. Further, the SCS 90 can recognize whether the reason why it cannot transmit the Non-IP Data to the UE 40 is that the time until the next communication enabled timing of the UE 40 in a power saving state comes exceeds the Maximum Latency of the Non-IP Data. For example, if the time until the next communication enabled timing of the UE 40 in a power saving state comes exceeds the Maximum Latency of the Non-IP Data, the SCS 90 recognizes that it cannot transmit the Non-IP Data to the UE 40. After that, even if the SCS 90 immediately retransmits the Non-IP Data, it cannot transmit the Non-IP Data to the UE 40. Accordingly, if the time until the next communication enabled timing of the UE 40 in a power saving state comes exceeds the Maximum Latency of the Non-IP Data, the SCS 90 can wait for retransmission of the Non-IP Data. Specifically, the SCS 90 can wait for retransmission of the Non-IP Data until it receives a message, from the SCEF 80, notifying that the UE 40 is brought into a state in which communication can be performed. Thus, it is possible to prevent unnecessary Non-IP Data that is not transmitted to the UE 40 from being transmitted to the SCEF 80.

Further, if the time until the next communication enabled timing of the UE 40 in a power saving state comes exceeds the Maximum Latency of the Non-IP Data, the SCEF 80 can notify the SCS 90 that the Non-IP Data cannot be transmitted to the UE 40. Further, if the UE 40 has been brought into a state in which communication can be performed, the SCEF 80 transmits a message requesting the SCS 90 to retransmit the Non-IP Data, thereby eliminating the need to buffer the Non-IP Data. Thus, it is possible to prevent the buffer capacity of the SCEF 80 from being reduced.

### Third Example Embodiment

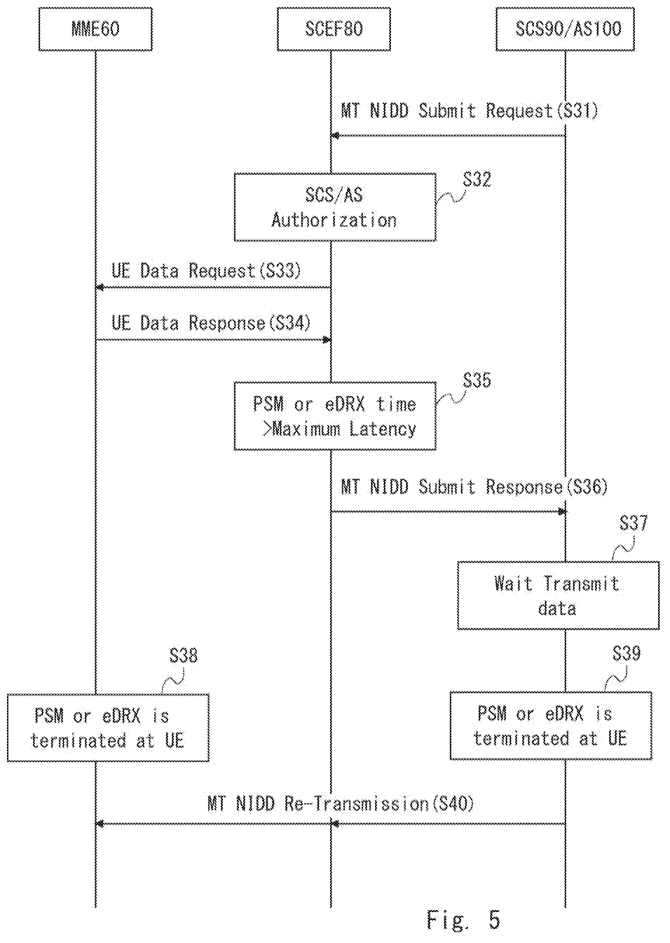

Next, an NIDD procedure according to a third example embodiment of the present disclosure is described with reference to FIG. 5. Steps S31 to S35 are similar to Steps S11 to S15 shown in FIG. 4, and thus detailed descriptions thereof are omitted.

In Step S35, if the SCEF 80 determines that the time until the next communication enabled timing of the UE 40 in a power saving state comes exceeds the Maximum latency of the Non-IP Data, the SCEF 80 transmits an MT NIDD Submit Response message to the SCS 90/AS 100 (S36).

The MT NIDD Submit Response message includes information indicating that the Non-IP Data cannot be transmitted to the UE 40 since the time until the next communication enabled timing of the UE 40 in a power saving state comes exceeds the Maximum Latency of the Non-IP Data. Further, the MT NIDD Submit Response message includes time information of the next communication enabled timing of the UE 40 or information of the time until the next communication enabled timing of the UE 40 comes.

If the SCS 90/AS 100 receives the MT NIDD Submit Response message, it does not transmit the Non-IP Data and waits as in the case of Step S17 in FIG. 4. Further, in Step S36, the SCS 90/AS 100 has received the time information of the next communication enabled timing of the UE 40 or the information of the time until the next communication enabled timing of the UE 40 comes. Accordingly, in Step S37, the SCS 90/AS 100 does not transmit the Non-IP Data and waits until the next communication enabled timing of the UE 40 comes.

Next, the MME 60 detects that the UE 40 has come to the communication enabled timing and has been brought into a state in which communication can be performed (S38). Further, the SCS 90/AS 100 has recognized the next communication enabled timing of the UE 40. Accordingly, the SCS 90/AS 100 detects that the UE 40 has been brought into a state in which communication can be performed at substantially the same timing as the timing at which the MME 60 detects that the UE 40 has been brought into a state in which communication can be performed (S39).

Next, the SCS 90/AS 100 transmits an MT NIDD Re-Transmission message including the Non-IP Data to the MME 60 via the SCEF 80 (S40). The Non-IP Data included in the MT NIDD Re-Transmission message is similar to the Non-IP Data transmitted in Step S31. That is, the SCS 90/AS 100 retransmits the Non-IP Data in Step S39 since the Non-IP Data transmitted in Step S31 has not been transmitted to the UE 40.

As described above, in Step S36, the SCS 90/AS 100 can receive the time information of the next communication enabled timing of the UE 40 or the information of the time until the next communication enabled timing of the UE 40 comes. Accordingly, the SCS 90/AS 100 can detect that the UE 40 has been brought into a state in which communication can be performed even if the SCS 90/AS 100 is not notified by the MME 60 via the SCEF 80 that the UE 40 has been brought into a state in which communication can be performed.

As a result, the SCS 90/AS 100 can retransmit the Non-IP Data based on the fact that the SCS 90/AS 100 has detected that the UE 40 has been brought into a state in which communication can be performed.

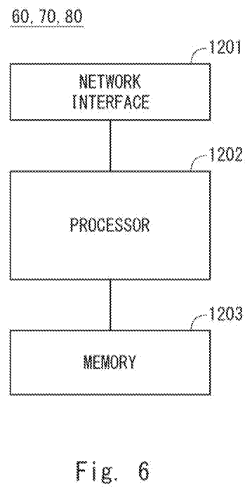

FIG. 6 is a block diagram showing a configuration example of each of the MME 60, the SGSN 70, and the SCEF 80. Referring to FIG. 6, the MME 60, the SGSN 70, and the SCEF 80 each include a network interface 1201, a processor 1202, and a memory 1203. The network interface 1201 is used to communicate with other network node apparatuses constituting the communication system. The network interface 1201 may include, for example, a network interface card (NIC) conforming to the IEEE 802.3 series.

The processor 1202 loads software (computer programs) from the memory 1203 and executes the loaded software (computer programs), thereby performing processing of the MME 60, the SGSN 70, and the SCEF 80 described with reference to the sequence diagram and the flowchart in the above-described example embodiments. The processor 1202 may be, for example, a microprocessor, a Micro Processing Unit (MPU), or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an I/O interface (not shown).

In the example shown in FIG. 6, the memory 1203 is used to store software modules. The processor 1202 can perform processing of the MME 60, the SGSN 70, and the SCEF 80 described in the above example embodiments by loading the software modules from the memory 1203 and executing the loaded software modules.

As described above with reference to FIG. 6, each of the processors included in the MME 60, the SGSN 70, and the SCEF 80 executes one or more programs including instructions to cause a computer to perform an algorithm described with reference to the drawings.

In the above-described examples, the program(s) can be stored and provided to a computer using any type of non-transitory computer readable media. Non-transitory computer readable media include any type of tangible storage media. Examples of non-transitory computer readable media include magnetic storage media, CD-ROM (Read only memory), CD-R, CD-R/W, and semiconductor memories. The magnetic storage media include, for example, flexible disks, magnetic tapes, hard disk drives, and optical magnetic storage media (e.g., magneto-optical disks). The semiconductor memories include, for example, mask ROM, programmable ROM (PROM), Erasable PROM (EPROM), flash ROM, Random Access Memory (RAM). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above example embodiments and may be changed as appropriate without departing from the spirit of the present disclosure. Further, the present disclosure may be executed by combining the example embodiments as appropriate.

The whole or part of the above example embodiments can be described as, but not limited to, the following supplementary notes.

(Supplementary Note 1)

A service control apparatus, comprising:

a communication unit configured to receive, from a service providing apparatus, downlink data destined for a communication terminal, and information about a maximum allowable delay time of the downlink data; and

a control unit configured to determine whether the maximum allowable delay time expires by a communication enabled timing at which the communication terminal in a power saving state can next perform communication, wherein

when the maximum allowable delay time expires by the communication enabled timing, the communication unit transmits, to the service providing apparatus, information indicating that the downlink data cannot be transmitted to the communication terminal.

(Supplementary Note 2)

The service control apparatus described in Supplementary Note 1, wherein the control unit acquires information about the communication enabled timing from a mobility management apparatus configured to perform mobility management of the communication terminal.

(Supplementary Note 3)

The service control apparatus described in Supplementary Note 1, wherein the control unit acquires information about the communication enabled timing from a subscriber information management apparatus configured to manage subscriber information about the communication terminal.

(Supplementary Note 4)

The service control apparatus described in any one of Supplementary Notes 1 to 3, wherein the communication unit transmits, to the service providing apparatus, information about the communication enabled timing of the communication terminal along with information indicating that the downlink data cannot be transmitted to the communication terminal.

(Supplementary Note 5)

The service control apparatus described in any one of Supplementary Notes 1 to 3, wherein when the communication terminal has been brought into a state in which communication can be performed, the communication unit transmits information indicating that the communication terminal can perform communication to the service providing apparatus.

(Supplementary Note 6)

The service control apparatus described in Supplementary Note 5, wherein when the communication unit receives information indicating that the communication terminal has been brought into a state in which communication can be performed from the mobility management apparatus configured to perform mobility management of the communication terminal, the communication unit transmits information indicating that the communication terminal can perform communication to the service providing apparatus.

(Supplementary Note 7)

The service control apparatus described in any one of Supplementary Notes 1 to 6, wherein the communication enabled timing is a recovery timing at which the communication terminal recovers from a Power Saving Mode (PSM) or a signal reception timing when the communication terminal intermittently receives a signal by a Discontinuous Reception (DRX).

(Supplementary Note 8)

A mobility management apparatus, comprising:

a determination unit configured to determine a communication enabled timing at which a communication terminal in a power saving state can next perform communication; and

a communication unit configured to transmit information about the communication enabled timing to a service providing apparatus configured to determine whether a maximum allowable delay time of downlink data destined for the communication terminal expires by the communication enabled timing at which the communication terminal in a power saving state can next perform communication.

(Supplementary Note 9)

The mobility management apparatus described in Supplementary Note 8, wherein when the communication unit receives a message requesting information about the communication enabled timing from the service providing apparatus, the communication unit transmits the information about the communication enabled timing to the service providing apparatus.

(Supplementary Note 10)

A service control method, comprising:

receiving, from a service providing apparatus, downlink data destined for a communication terminal, and information about a maximum allowable delay time of the downlink data;

determining whether the maximum allowable delay time expires by a communication enabled timing at which the communication terminal in a power saving state can next perform communication; and

transmitting, to the service providing apparatus, information indicating that the downlink data cannot be transmitted to the communication terminal when the maximum allowable delay time expires by the communication enabled timing.

(Supplementary Note 11)

A data transmission method, comprising:

determining a communication enabled timing at which a communication terminal in a power saving state can next perform communication; and

transmitting information about the communication enabled timing to a service providing apparatus configured to determine whether a maximum allowable delay time of downlink data destined for the communication terminal expires by the communication enabled timing at which the communication terminal in a power saving state can next perform communication.

(Supplementary Note 12)

A program for causing a computer to:

receive, from a service providing apparatus, downlink data destined for a communication terminal, and information about a maximum allowable delay time of the downlink data;

determine whether the maximum allowable delay time expires by a communication enabled timing at which the communication terminal in a power saving state can next perform communication; and

transmit, to the service providing apparatus, information indicating that the downlink data cannot be transmitted to the communication terminal when the maximum allowable delay time expires by the communication enabled timing.

(Supplementary Note 13)

A program for causing a computer to:

determine a communication enabled timing at which a communication terminal in a power saving state can next perform communication; and

transmit information about the communication enabled timing to a service providing apparatus configured to determine whether a maximum allowable delay time of downlink data destined for the communication terminal expires by the communication enabled timing at which the communication terminal in a power saving state can next perform communication.

While the present invention has been described with reference to the example embodiments, the present invention is not limited to the aforementioned example embodiments. Various changes that can be understood by those skilled in the art can be made to the configurations and the details of the present invention within the scope of the present invention.

This application is based upon and claims the benefit of priority from Japanese patent application No. 2017-181503, filed on Sep. 21, 2017, the disclosure of which is incorporated herein in its entirety by reference.

### REFERENCE SIGNS LIST

10 COMMUNICATION TERMINAL
20 SERVICE CONTROL APPARATUS
21 COMMUNICATION UNIT
22 CONTROL UNIT
30 SERVICE PROVIDING APPARATUS
40 UE
50 RAN
60 MME
61 COMMUNICATION UNIT
62 CONTROL UNIT
70 SGSN
80 SCEF
90 SCS
100 AS

1. A service control apparatus, comprising:
at least one memory storing instructions, and
at least one processor configured to execute the instructions to;
receive, from a service providing apparatus, downlink data destined for a communication terminal, and information about a maximum allowable delay time of the downlink data;
determine whether the maximum allowable delay time expires by a communication enabled timing at which the communication terminal in a power saving state can next perform communication, and
when the maximum allowable delay time expires by the communication enabled timing, transmit, to the service providing apparatus, information indicating that the downlink data cannot be transmitted to the communication terminal.

2. The service control apparatus according to claim 1, wherein the at least one processor is further configured to execute the instructions to acquire information about the communication enabled timing from a mobility management apparatus configured to perform mobility management of the communication terminal.

3. The service control apparatus according to claim 1, wherein the at least one processor is further configured to execute the instructions to acquire information about the communication enabled timing from a subscriber information management apparatus configured to manage subscriber information about the communication terminal.

4. The service control apparatus according to claim 1, wherein the at least one processor is further configured to execute the instructions to transmit, to the service providing apparatus, information about the communication enabled timing of the communication terminal along with information indicating that the downlink data cannot be transmitted to the communication terminal.

5. The service control apparatus according to claim 1, wherein the at least one processor is further configured to execute the instructions to, when the communication terminal has been brought into a state in which communication can be performed, transmit information indicating that the communication terminal can perform communication to the service providing apparatus.

6. The service control apparatus according to claim 5, wherein the at least one processor is further configured to execute the instructions to, when receiving information indicating that the communication terminal has been brought into a state in which communication can be performed from the mobility management apparatus configured to perform mobility management of the communication terminal, transmit information indicating that the communication terminal can perform communication to the service providing apparatus.

7. The service control apparatus according to claim 1, wherein the communication enabled timing is a recovery timing at which the communication terminal recovers from a Power Saving Mode (PSM) or a signal reception timing when the communication terminal intermittently receives a signal by a Discontinuous Reception (DRX).

8. A mobility management apparatus, comprising:
at least one memory storing instructions, and
at least one processor configured to execute the instructions to;
determine a communication enabled timing at which a communication terminal in a power saving state can next perform communication; and
transmit information about the communication enabled timing to a service providing apparatus configured to determine whether a maximum allowable delay time of downlink data destined for the communication terminal expires by the communication enabled timing at which the communication terminal in a power saving state can next perform communication.

9. The mobility management apparatus according to claim 8, wherein the at least one processor is further configured to execute the instructions to, when the receiving a message requesting information about the communication enabled timing from the service providing apparatus, transmit the information about the communication enabled timing to the service providing apparatus.

10. A service control method, comprising:
receiving, from a service providing apparatus, downlink data destined for a communication terminal, and information about a maximum allowable delay time of the downlink data;
determining whether the maximum allowable delay time expires by a communication enabled timing at which the communication terminal in a power saving state can next perform communication; and
transmitting, to the service providing apparatus, information indicating that the downlink data cannot be transmitted to the communication terminal when the maximum allowable delay time expires by the communication enabled timing.

11. (canceled)

12. (canceled)

13. (canceled)
